(19) United States
(12) Patent Application Publication
(10) Pub. No.: US 2010/0175812 A1
(43) Pub. Date: Jul. 15, 2010

(54) METHOD OF AND APPARATUS FOR MANUFACTURING A BELT MEMBER

(75) Inventors: Shigeo Kudo, Osaka (JP); Tetsuo Tatara, Osaka (JP); Osamu Fujiki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYO TIRE & RUBBER CO., LTD., Osaka-shi, Osaka (JP)

(21) Appl. No.: 12/601,390

(22) PCT Filed: Aug. 21, 2007
(86) PCT No.: PCT/JP2007/066182

§ 371 Date: Nov. 23, 2009

(51) Int. Cl. B05D 3/12; B05C 9/12

(52) U.S. Cl. 156/117; 156/397

(57) ABSTRACT

The invention makes a rubber covering process for cords and processes of cutting and aligning cords a series of processes to enable simplification of installations and processes and manufactures a belt member of high quality, in which straightness and rubber adhesiveness of cords can be improved. As measures therefor, a belt member 50 of a predetermined width, in which a single cord C is made oblique, is fabricated by feeding a single cord C while maintaining straightness thereof in a longitudinal direction, passing the cord through a rubber covering die 15 during the feed to cover the cord C with rubber, subsequently feeding a tip end side portion of the rubber covered cord C1 to a constant rate cut line 20 to cut the tip end side portion of the rubber covered cord C1 every feed, and feeding the rubber covered cord C1 having been cut to an alignment table 30 in a state of maintaining the straightness to sequentially align and join the same obliquely to a cord direction.

### TECHNICAL FIELD

The present invention relates to a method of and apparatus for manufacturing a belt member used as a tire reinforcement member.

### BACKGROUND ART

A radial tire is formed from a plurality of tire constituent members. As shown in, for example, FIG. 9, a tire T is formed by combining rubber members such as an inner liner 2, a tread 3, side walls 4, rim strips 5 and tire reinforcement members such as a carcass layer 1, a belt layer 7, which include cords made of fiber and metal. The reference numeral 8 in the figure denotes bead portions including bead cores 9.

A belt member used for the belt layer 7 of the radial tire comprises a multiplicity of reinforcement cords such as steed cord aligned and embedded in a rubber material, the cords being inclined at a predetermined angle to a tire circumferential direction.

Conventionally, a lengthy belt member is fabricated by covering reinforcement cords composed of metallic strand element wire such as steed cord and put in a state of being aligned in parallel in a planar manner with rubber in a calendar process of plant to form a lengthy, relatively wide band-shaped material to once wind the same on a bobbin, conveying the material to a subsequent process, performing so-called bias-cutting for the band-shaped material pulled out of the bobbin to a predetermined angle, a predetermined length, and a predetermined width, and aligning and joining the band-shaped material as cut in a manner to make both side portions, which are not cut, butt against each other. Usually, a lengthy belt member formed in the manner described above is wound in a rolled manner to be stocked and conveyed to a molding process of a belt layer in tire molding to be consumed.

In the method of manufacturing a tire belt member, however, the process of covering reinforcement cords with rubber to form a lengthy band-shaped material and the cutting and joining processes of cutting the band-shaped material and aligning and joining band-shaped pieces as cut are performed separately, so that devices and installations in the respective processes become large in size and high in installation cost and are bad in workability due to conveyance or the like between the processes to be responsible for prevention of an improvement in workability and productivity. Also, the method is poorly conformed to manufacture of a belt member, cords of which are different in angle of inclination and width, and so not suited to production of small quantity and large variety.

Therefore, in recent years, as disclosed in the following Document 1 and Document 2, it is proposed that a belt member having a length corresponding to a single tire circumference be manufactured by passing a plurality of reinforcement cords pulled out of bobbins of a creel stand through a rubber covering device in an aligned state to cover the same with rubber, cutting a band-shaped member, as obtained, having a relatively small wide obliquely to a longitudinal direction while obliquely feeding the band-shaped member to a delivery conveyor, and joining sides of belt material pieces as cut on the delivery conveyor and the belt member be transferred directly to a molding drum to form a tire.

In the case of the proposal, however, reinforcement cords, such as steel cord, pulled out of a plurality of bobbins of a creel stand are passed as they are in an aligned state through the rubber covering device to be covered with rubber and fed to the cutting and aligning processes by a feeding device provided subsequently to the rubber covering device. Therefore, until then, the cords pulled out of the bobbins are remained in a wound state over long term inducing tendency to bend causing a problem in straightness. Consequently, there is a fear that stress is generated in internal cords put in a state of being covered with rubber and cord spacings become nonuniform, there is caused a problem that joint failure is caused in alignment and junction after cutting, and hence there is a fear of damage to the quality of a belt material.

Also, when adhesiveness of rubber to cords pulled out of bobbins is weak, there is a fear of separation or the like in use for a tire, so that it is desirable to improve the adhesiveness as much as possible but a sufficient measure therefor is not adopted.

### Patent Document 1: JP-A-11-99564

### Patent Document 2: JP-A-2000-280373

### DISCLOSURE OF THE INVENTION

### Problems that the Invention is to Solve

The invention solves such problem and has its object to provide a method of and an apparatus for manufacturing a tire belt member, in which a rubber covering process for cords, such as wire, for a belt member and subsequent processes of cutting and aligning rubber covered cords are made a series of continuous processes in manufacture of a belt member used for manufacture of radial tires to enable simplification of installations and processes for manufacture of a belt member, and straightness and rubber adhesiveness of cords in manufacture of a belt member can be improved to readily manufacture a belt member of high quality owing to alignment of a single cord.

### Means for Solving the Problems

One of the inventions has a feature in a method of manufacturing a tire belt member, the method comprising feeding a single belt material cord forwarded from a supply section while maintaining straightness thereof in a longitudinal direction, passing the cord through a rubber covering die during the feed to cover the cord with rubber, subsequently feeding a tip end side portion of the rubber covered cord to a constant rate cut line to cut the tip end side portion of the rubber covered cord to a predetermined length every feeding by the predetermined length, and feeding the rubber covered cord having been cut to an alignment table in a state of maintaining the straightness to sequentially align and join the same obliquely to a cord direction to form a belt member of a predetermined width, in which the cord is made oblique.

Thereby, a rubber covering process for cords for a belt member and subsequent processes of cutting and aligning rubber covered cords are made a series of processes and can be carried out to enable simplification of installations and processes for manufacture of a belt member. Uniformity in using a rubber covering die to cover surfaces of a cord with rubber in the rubber covering process and the processes of cutting and aligning rubber covered cords can be achieved by maintaining the straightness of the cord and the rubber covered cord having been cut can be sequentially aligned and joined on the alignment table without strain.

In the method of manufacturing a tire belt member, preferably, the belt material cord is passed through a high-temperature atmosphere to achieve an increase in temperature of the cord itself and then passed through the rubber covering die to be covered with rubber, whereby it is possible to heighten adhesiveness of rubber to cords.

Also, in the method of manufacturing a tire belt member, preferably, while straightness of a rubber covered cord having been cut and having a predetermined length is corrected on the constant rate cut line, the rubber covered cord is fed to the alignment table. Thereby, a rubber covered cord having been cut can be sequentially aligned and surely joined over a total length without strain.

Also, an apparatus for manufacturing a tire belt member, according to the invention, comprises a feeding device that feeds a single belt cord forwarded from a supply section in a longitudinal direction while maintaining straightness thereof, a rubber covering die that passes therethrough the belt cord during straight feeding to cover the cord with rubber, a constant rate cut line including a cutting device, by which a tip end side portion of the rubber covered cord intermittently fed through a festoon device is cut to a predetermined length every feeding by the predetermined length on a downstream side of a straight fed portion of the rubber covered cord passed through the rubber covering die, and straightness correcting means having the forwarding function of once holding a tip end side portion of the rubber covered cord forwarded through a portion of the cutting device and forwarding the rubber covered cord as cut every cutting action performed by the cutting device while correcting straightness thereof, and an alignment table provided with a junction device, by which the rubber covered cord as cut and forwarded from the constant rate cut line is sequentially aligned and joined obliquely to a cord direction.

With the apparatus for manufacturing a tire belt member, a rubber covering process for cords and processes of cutting and aligning rubber covered cords are made a series of processes and the manufacturing can be carried out favorably. In particular, it is possible on the constant rate cut line to sequentially feed the rubber covered cord as cut to the alignment table every cutting action of the rubber covered cord while correcting straightness thereof with straightness correcting means having the forwarding function, thus enabling sequential alignment of the cord without strain to surely join the same over a total length.

Also, in the apparatus for manufacturing a tire belt member, preferably, a warm-up device is provided upstream of the rubber covering die on a straight fed portion of the belt cord to pass therethrough the cord to heat and raise the same in temperature. Thereby, since the cord can be covered with rubber after being raised in temperature, it is possible to heighten adhesiveness of rubber to the cord.

In the apparatus for manufacturing a tire belt member, a first pinch roll and a second pinch roll, which serve as a feeding device of the belt cord, are arranged at an interval in a feeding direction to posses the straightness correcting function and the warm-up device and the rubber covering die are provided in series between the first pinch roll and the second pinch roll. Thereby, it is possible to favorably maintain straightness of the cord passing through the rubber covering die, thus enabling uniform covering of surfaces of a cord with rubber.

In the apparatus for manufacturing a tire belt member, preferably, a straightness correcting line, on which plural pairs of forming rolls are arranged to interpose a rubber covered cord from both sides to correct straightness thereof, is provided on a downstream side of a straight fed portion of the belt cord. Thereby, it is possible to favorably maintain straightness of the rubber covered cord.

In the apparatus for manufacturing a tire belt member, preferably, the straightness correcting means of the constant rate cut line having the forwarding function comprises plural pairs of forming rolls that interpose a rubber covered cord from both sides to correct straightness thereof, and the forming rolls are provided to be enabled by drive means connected thereto to be rotationally driven to forward a rubber covered cord as cut. Thereby, it is possible to positively feed the rubber covered cord as cut to the alignment table in a state of maintaining the straightness.

Further, in the apparatus for manufacturing a tire belt member, the junction device on the alignment table comprises a roller that receives the rubber covered cord as cut and fed from the constant rate cut line in a manner to align the same with the rubber covered cord as aligned on the alignment table, and push means that makes use of a cam mechanism to pressure contact and join the rubber covered cord as cut and fed onto the roller to the rubber covered cord as aligned. Thereby, it is possible to sequentially align the rubber covered cord as aligned to join the same without any problem.

### EFFECT OF THE INVENTION

With the method of and the apparatus for manufacturing a tire belt member, according to the invention, a rubber covering process for cords, such as wire, for a belt member and subsequent processes of cutting and aligning rubber covered cords are made a series of continuous processes to enable simplification of installations and processes for manufacture of a belt member to realize reduction in installation cost and an improvement in workability. Besides, it is possible to improve a cord in straightness and adhesiveness of rubber in manufacture of a belt member, thus enabling easy manufacturing of a belt member of high quality owing to alignment and joining of a single cord as cut.

### BEST MODE FOR CARRYING OUT THE INVENTION

A mode for carrying out the invention will be described below on the basis of an embodiment shown in the drawings.

FIG. 1 is a schematic, plan view showing the outline of a whole apparatus for carrying out a method of manufacturing a tire belt member according to the invention.

FIG. 2 is a schematic, cross sectional view showing, in enlarged scale, a portion of a warm-up device.

FIGS. 3 and 4 are a schematic, side view and a schematic, cross sectional view showing, in enlarged scale, a straightness correcting line.

In the drawings, the character C denotes a belt cord composed of a steel cord and other metallic cords, which are formed mainly by twisting element wires. The belt cord C is normally set so that it can be forwarded in a state of being wound on a bobbin B to a supply section 11 in a rubber covering process 10. The belt cord C is set in material, thickness, or the like according to a kind, a size, etc. of a belt material being manufactured.

The reference numerals 12 and 13 denote first and second pinch rolls serving as a forwarding device that forwards a single belt cord C forwarded from the supply section 11, and arranged at an interval in a forwarding direction to posses the straightness correcting function, the pinch rolls being provided to enable straight forwarding of the cord C while applying a predetermined tension thereon between the both pinch rolls 12, 13 and correcting straightness thereof.

A rubber covering die 15 is provided between the first pinch roll 12 and the second pinch roll 13 to pass therethrough the belt cord C, which is forwarded straight between the both pinch rolls 12, 13, to cover the cord C with rubber. In the case shown in the figure, in order to improve adhesiveness of rubber to the cord C, a warm-up device 14 that heats and warms up the cord C during forwarding is provided a little upstream in the forwarding direction of the cord C so that the cord C in a heated state after the passage through the warm-up device 14 is passed through the rubber covering die 15. Thereby, it is possible to cover surfaces of the cord C with the rubber with good adhesiveness.

As shown in FIG. 2, the warm-up device 14 is provided so that one or plural heating coils 14b are arranged in the forwarding direction of the belt cord C within a box-shaped device body 14a and the cord C passes through a high-temperature atmosphere generated by energization of the heating coils 14b whereby the cord C can be heated to a predetermined temperature. The heating coils 14b can be set to an optional heating temperature by controlling energization with the use of a thermostat or the like.

The rubber covering die 15 is provided contiguous to a discharge side of an extruder (not shown) of unvulcanized rubber and includes therein a rubber retaining section, which temporarily retains rubber discharged from the extruder to adjust pressure, and a rubber covering and molding passage, through which the cord passes, forwardly of the rubber retaining section (depiction of both elements is omitted) in the same manner as conventional rubber covering dies while a detailed depiction and illustration are omitted, and the straight forwarded cord C enters from the rear to pass through the rubber retaining section and the rubber covering and molding passage whereby it is possible to cover the surfaces of the cord C with rubber.

The reference numeral 16 denotes a straightness correcting line, by which the cord C passed through the rubber covering die 15 to be forwarded and having been covered with rubber, that is, a rubber covered cord C1 is interposed from both sides and forwarded forwardly (downstream) of the second pinch roll 13 in the cord forwarding direction while straightness thereof is corrected.

As shown in FIGS. 4 and 5, the straightness correcting line 16 comprises plural pairs of forming rolls 17, 17 that are arranged and paired facing to each other on both sides with a forwarded portion of the rubber covered cord C1 therebetween. The respective forming rolls 17, 17 on the both sides include grooves, which have a substantially semi-circular shaped section and into which the rubber covered cord C1 is fitted, on outer peripheries thereof, and vertical shaft portions 17a, 17a thereof are connected to and supported on flat-plate guides 19, 19 on both sides through spring means 18, 18 such as spring, so that the rubber covered cord C1 can be elastically interposed from both sides with a substantially constant pressure and forwarded while straightness thereof is corrected.

The both forming rolls 17, 17 supported by the flat-plate guides 19, 19 on the both sides are preferably supported to be arranged so that a direction of alignment is slightly inclined by the flat-plate guides 19, 19 so that a spacing between the respective rolls on the both sides is slightly large on a side, onto which the rubber covered cord C1 enters, and assumes a standard size as set on a forwarding side. Also, preferably, positions of the respective forming rolls 17, 17 on the both sides can be individually adjusted by the flat-plate guides 19, 19.

A roller encoder (depiction is omitted) for length measurement is provided on a rearmost (most downstream position) roll out of the forming rolls 17, 17 of the straightness correcting line 16 to enable measuring of the length of the rubber covered cord C1 as forwarded.

Also, preferably, rubber having an antislipping effect covers surfaces of the grooves on the outer peripheries of the respective forming rolls 17, 17, and more specifically, surfaces of the covering rubber are subjected to rugged finish.

A constant rate cut line 20 is provided forwardly (downstream) of the straightness correcting line 16 in the cord forwarding direction to perform a cutting process, in which a tip end side portion of the rubber covered cord C1 intermittently forwarded through a festoon device 21, which stops forwarding of the cord to temporarily store the same, is cut to a predetermined length.

The constant rate cut line 20 includes a cutting device 22 that cuts the rubber covered cord C1 to a predetermined length each time the cord is forwarded the predetermined length, and straightness correcting means 23 having the forwarding function of once holding a tip end side portion of the rubber covered cord C1 forwarded through a portion of the cutting device 22 and forwarding the rubber covered cord C1 as cut (referred below to as cut cord C1a) every cutting action performed by the cutting device 22 while correcting straightness of the cord.

With the embodiment shown in the figure, plural pairs of forming rolls 24, 24, outer peripheries of which have grooves having a substantially semi-circular shaped section, as the straightness correcting means 23 are arranged and paired on both opposite sides over a length range in the order of the cut length with a forwarded portion of the rubber covered cord C1 therebetween. The respective forming rolls 24, 24 are provided to be connected together by transmission members 27 such as endless belt, chain stretched on pulleys 26, 26 provided on shaft portions 25, 25 thereof to enable transmission and intermittently and rotationally driven by drive means (not shown), such as motor, connected to one of the pulleys 26, so that a tip end side portion of the rubber covered cord C1 forwarded intermittently through the cutting device 22 is interposed from both sides by the forming rolls 24, 24 to be once held and the cut cord C1a can be forwarded after the cutting operation while straightness thereof is corrected.

While various cutting devices such as scissors-type and rotating blade type ones can be used for the cutting device 22, a scissors-type cutting device with rubbing of two blades produces a clear cut surface, is inexpensive, easy to handle, and especially used preferably since the cord C is composed of strand wire.

A forwarding side of the constant rate cut line 20 is connected to a portion of a junction device 31, which is provided obliquely to a longitudinal direction of an alignment table 30, to be aligned thereto on a straight line, and the cut cord C1a forwarded intermittently every cutting action by the cutting device 22 can be forwarded to a predetermined position on a portion of the junction device 31.

That is, the junction device 31 is provided on the alignment table 30 obliquely to a direction, in which a belt material 50 being manufactured is forwarded from the alignment table 30, to sequentially align and join the cut cord C1a as cut and forwarded in the manner described above obliquely at an angle conformed to a cord direction of the belt material, the junction device 31 being mounted obliquely to the alignment table 30 so that the constant rate cut line 20 is aligned on a straight line in the same direction as that of the junction device 31. In other words, a cord forwarding direction from the rubber covering process of the belt cord C to the cutting process is made oblique to the alignment table 30 and provided in the same direction as that of the junction device 31 on the alignment table 30.

In the case shown in the figure, a separating section 33 is provided between the constant rate cut line 20 and the junction device 31 so as to enable forwarding of the cut cord C1a to the junction device 31 at a larger speed than that speed, at which the rubber covered cord C1 forwarded from an upstream side of the cutting device 22 is forwarded, when being forwarded from the straightness correcting means 23 of the constant rate cut line 20. Thereby, a speed of forwarding by the separating section 33 and a receiving drive roll of the junction device 31 is set to be a little larger than a forwarding speed of the rubber covered cord C1 forwarded to the constant rate cut line 20.

The junction device 31 has a construction, shown in, for example, FIGS. 6 to 8, as means, by which the cut cord C1a forwarded one by one is sequentially aligned and joined.

In FIGS. 6 to 8, a plurality of receiving drive rollers 35 for reception of the cut cord C1a forwarded from the constant rate cut line 20 in the same level as that of an upper surface of the alignment table 30 are arranged in a slit section 32 obliquely cut on a part of the alignment table 30 to be aligned in a cord entering direction, so that the cut cord C1a is received in parallel to that aligned cord C1b at a belt material end, which is aligned and joined on a side edge of the slit section 32 of the alignment table 30. The receiving drive rollers 35 comprise a drive roller capable of rotational driving only in one direction and can hold the cut cord C1a once received in a predetermined position.

It is possible to normally detect reception of the cut cord C1a with a sensor or the like to stop rotational driving of the receiving drive rollers 35 to stop the cut cord C1a in the predetermined position.

A push roller 36 is arranged in parallel to the cut cord C1a received on the cord receiving drive rollers 35 to push the cut cord C1a against that aligned cord C1b at a belt material end, which is aligned on the end edge of the alignment table 30 by the slit section 32. In the case shown in the figure, the push roller 36 comprises a plurality of roller bodies 36b provided at intervals in a longitudinal direction of a shaft portion 36a, the shaft portion 36a being supported by a support member 37 provided to be able to swing about a position below axes of the receiving drive rollers 35. The support member 37 is normally biased by spring means 38, such as spring, in a direction, in which the pushing action is released, and provided so that a cam 39 abutting on the support member 37 is appropriately rotated by rotational driving of drive means 40 to swing in a direction of pushing action against the bias of the spring means 38 to push and act the cut cord C1a.

A cam shaft 41 mounting thereto the cam 39 is connected to the drive means 40, such as motor, through rotation transmitting means 42 such as gear and provided so that the cam 39 is rotated by rotational driving of the drive means 40 to push and move the support member 37.

Feed means and guide means can be appropriately provided on the alignment table 30 so that belt members being sequentially aligned and joined can be fed intermittently by a joined portion of the cut cord C1a in a direction of forwarding from the table.

Further, a forwarding conveyor 44 is connected to the alignment table 30 through a festoon device 43 and provided in a manner to enable sequentially forwarding a belt member as fabricated, so that it is possible to cut a belt member as forwarded to a predetermined length corresponding to a single tire circumference to supply the same to a tire molding process, or to once wind the belt member in a lengthy state to supply the same to a succeeding molding process.

In addition, that construction of the junction device 31, which is related to the pushing action by the push roller 36, is not limited to utilization of the cam 39 but it is also possible to make use of a cylinder device to perform the pushing action or to perform the pushing action by driving means, which makes use of a gear. Also, it does not matter whether the push roller 36 is replaced by a single lengthy roller provided on an axis or a plurality of roller bodies provided in parallel to perform the pushing action. Further, in place of the push roller 36, a push member such as plate can be provided to make push and junction.

An explanation will be given to the case where a method of fabricating a belt member according to the invention is carried out by the manufacturing apparatus described above.

A single belt cord C forwarded from the supply section 11 is advanced straight and forwarded in the longitudinal direction by the use of the first pinch roll 12 and the second pinch roll 13, which serve as a forwarding device. In particular, the cord C is held and forwarded straight between the first pinch roll 12 and the second pinch roll 13 with a predetermined tension to first pass through a high-temperature atmosphere by the heating coils 14b inside the warm-up device 14 in the forwarding portion between the both pinch rolls 12, 13 to be forwarded in a state of being heated to a predetermined temperature and raised in temperature, and then passes through the rubber covering die 15 whereby it is covered with rubber. At this time, the belt cord C is covered with good adhesiveness since it passes through the warm-up device 14 to be heated.

The rubber covered cord C1 covered with rubber in the manner described above passes between the forming rolls 17, 17 on both sides of the straightness correcting line 16 via the second pinch roll 13 whereby it is forwarded while straightness is corrected by eliminating a winding curl of the cord itself, which is caused by winding, or the like. Then, a tip end side portion of the rubber covered cord C1 is forwarded intermittently to the constant rate cut line 20 through the cutting device 22 in the cutting process via the festoon device 21.

In the constant rate cut line 20, each time the tip end side portion of the rubber covered cord C1 is forwarded a predetermined length, forwarding the predetermined length is detected by a sensor (not shown), etc., rotational driving of the forming rolls 24, 24 in the constant rate cut line 20 is stopped, the rubber covered cord C1 as forwarded is held in a predetermined position, and further simultaneously with stoppage of the forwarding, the cutting device 22 provided on an entering side of the constant rate cut line 20 is actuated to cut the tip end side portion of the rubber covered cord C1 to a predetermined length. In the meantime, the rubber covered cord C1 forwarded continuously through the warm-up device 14 and the rubber covering die 15 is temporarily stored in the festoon device 21 to standby for subsequent forwarding of the tip end side portion after the cutting.

When the cutting operation is completed, the forming rolls 24, 24 of the constant rate cut line 20 are rotationally driven to forward the rubber covered cord as cut, that is, the cut cord C1a to a portion of the junction device 31 on the alignment table 30 in a state, in which straightness is corrected and maintained. Thereby, it is possible to feed the cut cord C1a onto the receiving drive rollers 35 of the junction device 31 while straightness of the cut cord C1a is ensured and to align the cut cord precisely in parallel to the aligned cord C1b at a belt edge. At this time, the tip end side portion of the rubber covered cord C1 is forwarded straight to the cord forwarding side to be fed to the constant rate cut line 20 through a portion of the cutting device 22.

At this time, the separating section 33 provided between the constant rate cut line 20 and the junction device 31 of the alignment table 30 quickens forwarding of the cut cord C1a to the junction device to separate the cut cord from the tip end side portion of the rubber covered cord C1 forwarded intermittently to the constant rate cut line 20.

The cut cord C1a forwarded to a portion of the junction device 31 on the alignment table 30 is received in parallel to the aligned cord C1b at a belt edge of the belt material 50, which is aligned and joined on the side edge of the slit section 32 of the alignment table 30, and stopped.

In this state, the push roller 36 as push means of the junction device 31 is caused by the cam 39, which is driven by a motor, to swing against the bias of the spring means 38 to push and join the cut cord C1a to the aligned cord C1b at a belt material end on the side edge of the slit section 32 of the alignment table 30 and to push and move the cut cord C1a onto an end edge of the alignment table 30. Thereby, the cut cord C1a is joined to the aligned cord C1b at a belt material edge in a state of being covered with rubber and fed by a single cord in the direction of forwarding from the alignment table 30.

As described above, by sequentially repeating feeding of the rubber covered cord C1 as continuously fed, cutting of the rubber covered cord C1 each time it is intermittently fed to the constant rate cut line 20, and feeding, aligning and joining of the cut cord C1a as cut to the junction device 31, it is possible to continuously fabricate and manufacture a belt material 50, in which the belt cord C for reinforcement is made oblique to a longitudinal direction, from a single cord.

Accordingly, since the respective rubber covered cords C1 as cut, that is, the belt cords C are sequentially aligned and joined one by one in the belt material 50 manufactured in the manner described above, joined portions as in the case where conventional band-shaped pieces are joined are not formed at intervals in a longitudinal direction of a belt material, that is, in a tire circumferential direction but it is possible to fabricate the belt material 50 in a substantially uniformly joined state over a total length and hence to improve a tire in uniformity to provide a tire being good in weight balance.

Also, since the belt cord C is wound on the bobbin B, winding curl is generated to impede straightness in some cases, but according to the invention the cord C is forwarded straight to be covered with rubber while straightness thereof is corrected, and further straightness is corrected at the time of feeding to the cutting process and forwarding of the cut cord C1a as cut to the junction device 31 whereby it is possible to uniformize the aligned and joined state of the respective cut cords C1a over a total length to manufacture a belt material of good quality.

In addition, while the embodiment has been described with respect to the case where the belt cord C is composed of a metallic cord such as steel cord, the invention can be applied to the case where a cord made of fiber, such as aramid fiber, having a strength is used and produce the same effect.

### INDUSTRIAL APPLICABILITY

The invention can be preferably made use of in manufacturing a belt material used in a belt layer of a tire, that is, a belt material, cords of which are oblique to a longitudinal direction.

### BRIEF DESCRIPTION OF THE DRAWINGS

FIG. 1 is a schematic, plan view showing the outline of a whole apparatus that carries out a method of manufacturing a tire belt member according to the invention.

FIG. 2 is a schematic, cross sectional view showing, in enlarged scale, a portion of a warm-up device.

FIG. 3 is a schematic, side view showing a straightness correcting line.

FIG. 4 is a schematic, cross sectional view showing, in enlarged scale, the straightness correcting line.

FIG. 5 is a schematic, side view showing a constant rate cut line.

FIG. 6 is a schematic, plan view showing, in enlarged scale, a portion of a junction device.

FIG. 7 is a schematic, cross sectional view showing, in enlarged scale, the portion of the junction device before junction.

FIG. 8 is a schematic, cross sectional view showing, in enlarged scale, the portion of the junction device in a joined state.

FIG. 9 is a cross sectional view showing a tire structure.

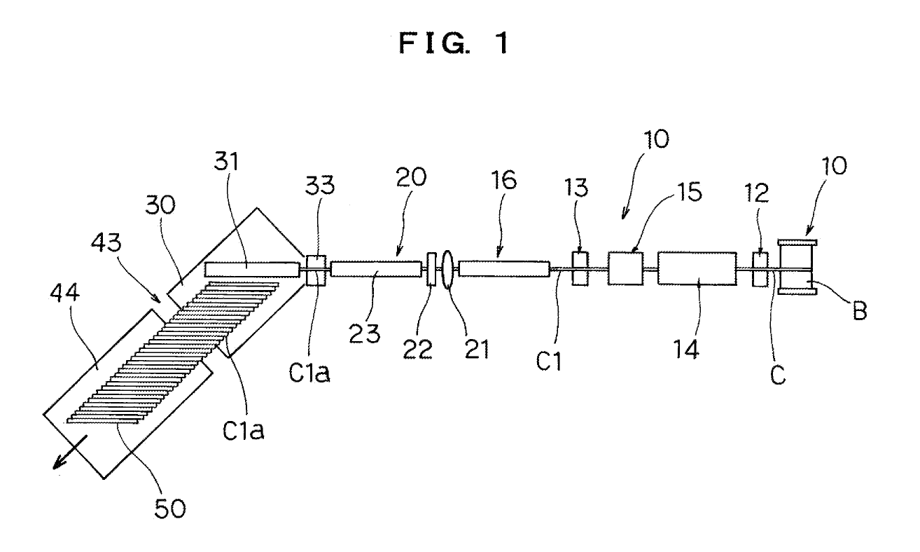

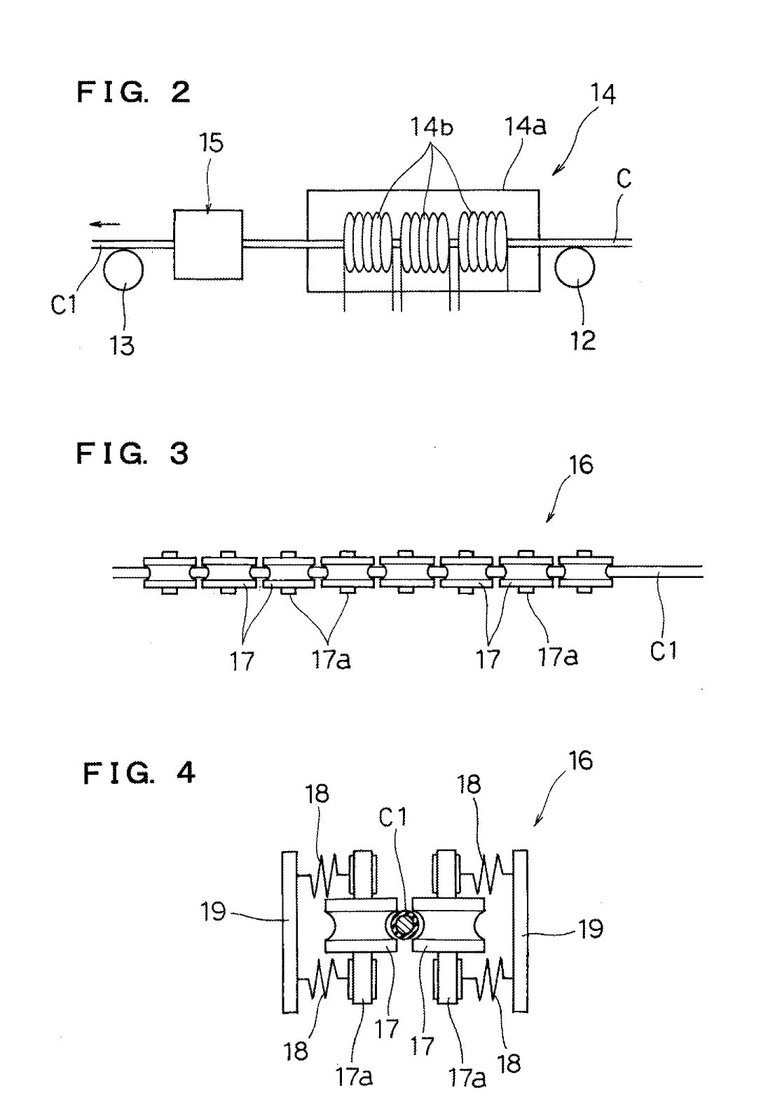

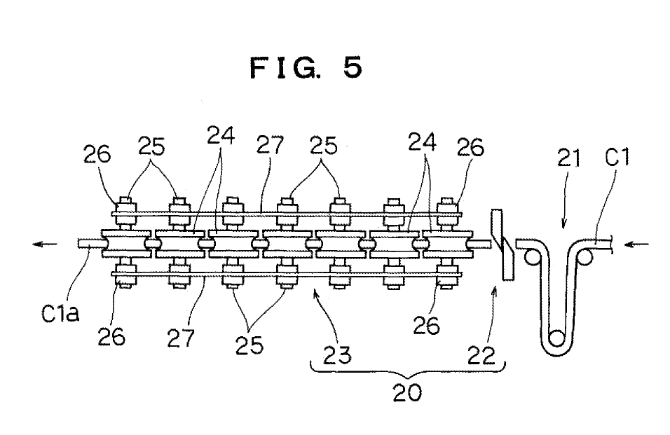

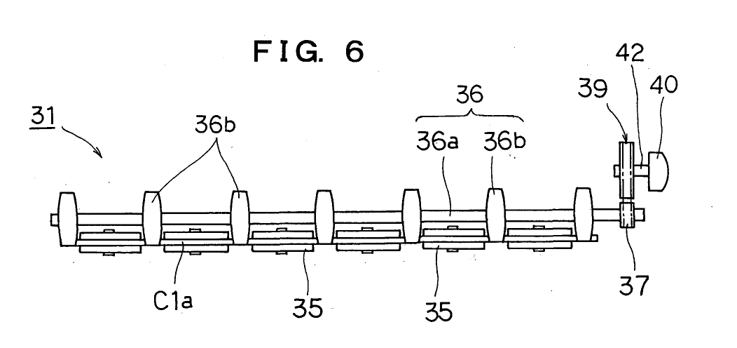

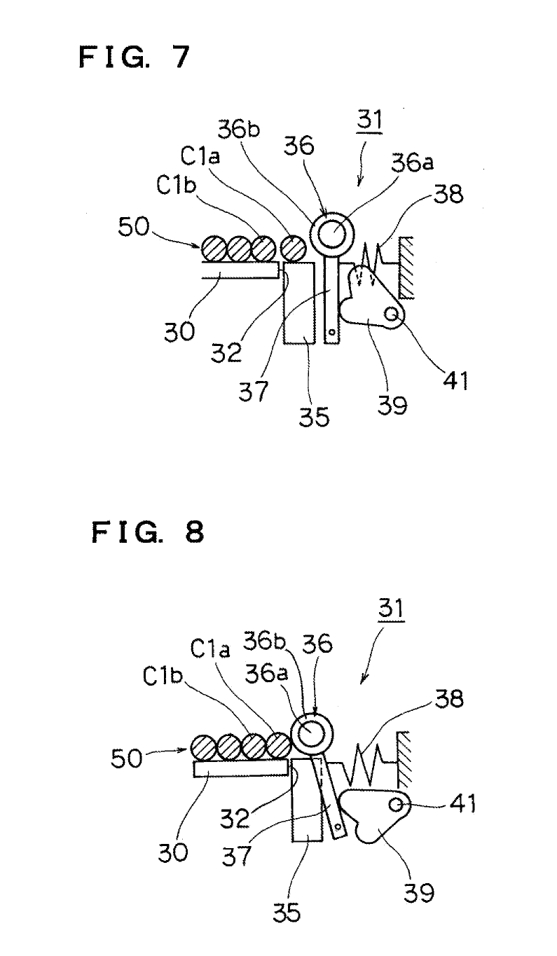

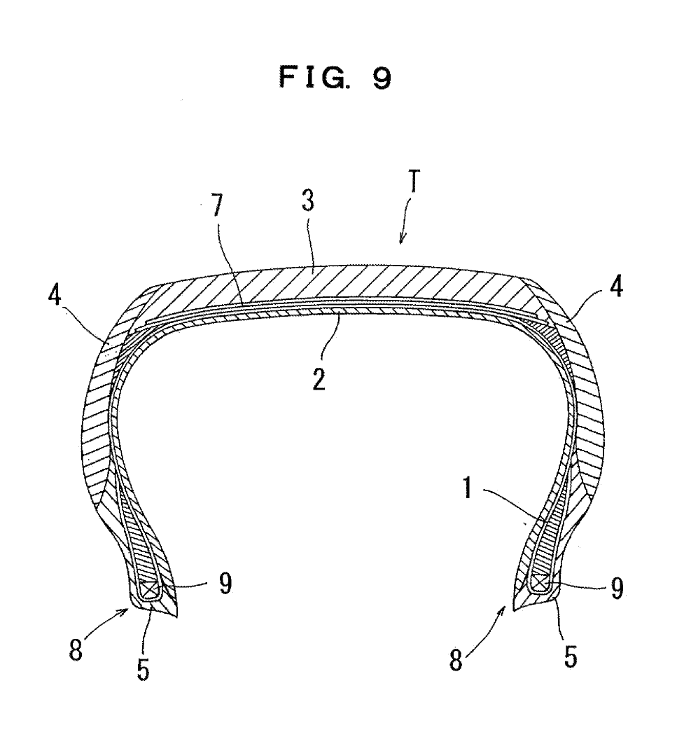

### DESCRIPTION OF REFERENCE NUMERALS AND SIGNS

B: bobbin, C: belt cord, C1: rubber covered cord, C1a: cut cord, 10: rubber covering process, 11: supply section, 12: first pinch roll, 13: second pinch roll, 14: warm-up device, 14a: device body, 14b: heating coil, 15: rubber covering die, 16: straightness correcting line, 17: forming roll, 17a: shaft portion, 18: spring means, 19: flat-plate guide, 20: constant rate cut line, 21: festoon device, 22: cutting device, 23: straightness correcting means, 24: forming roll, 25: shaft portion, 26: pulley, 27: transmission member, 30: alignment table, 31: junction device, 32: slit, 33: separating section, 35: receiving drive roller, 36: push roller, 36a: shaft portion, 36b: roller body, 37: support member, 38: spring means, 39: cam, 40: drive means, 41: camshaft, 42: rotation transmitting means, 43: festoon device, 44: forwarding conveyor

1. A method of manufacturing a tire belt member, the method comprising feeding a single belt material cord forwarded from a supply section while maintaining straightness thereof in a longitudinal direction, passing the cord through a rubber covering die during the feed to cover the cord with rubber, subsequently feeding a tip end side portion of the rubber covered cord to a constant rate cut line to cut the tip end side portion of the rubber covered cord to a predetermined length every feeding by the predetermined length, and feeding the rubber covered cord having been cut to an alignment table in a state of maintaining the straightness to sequentially align and join the same obliquely to a cord direction to form a belt member of a predetermined width, in which the cord is made oblique.

2. The method of manufacturing a tire belt member, according to claim 1, wherein the belt material cord is passed through a high-temperature atmosphere to achieve an increase in temperature of the cord itself and then passed through the rubber covering die to be covered with rubber.

3. The method of manufacturing a tire belt member, according to claim 1 or 2, wherein while straightness of a rubber covered cord having been cut and having a predetermined length is corrected on the constant rate cut line, the rubber covered cord is fed to the alignment table.

4. An apparatus for manufacturing a tire belt member, the apparatus comprising
a feeding device that feeds a single belt cord forwarded from a supply section in a longitudinal direction while maintaining straightness thereof,
a rubber covering die that passes therethrough the belt cord during straight feeding to cover the cord with rubber,
a constant rate cut line including a cutting device, by which a tip end side portion of the rubber covered cord intermittently fed is cut to a predetermined length every feeding by the predetermined length on a downstream side of a fed portion of the rubber covered cord passed through the rubber covering die, and straightness correcting means having the forwarding function of once holding a tip end side portion of the rubber covered cord forwarded through a portion of the cutting device and forwarding the rubber covered cord as cut every cutting action performed by the cutting device while correcting straightness thereof, and
an alignment table provided with a junction device, by which the rubber covered cord as cut and forwarded from the constant rate cut line is sequentially aligned and joined obliquely to a cord direction.

5. The apparatus for manufacturing a tire belt member, according to claim 4, wherein a warm-up device is provided upstream of the rubber covering die on a straight fed portion of the belt cord to pass therethrough the cord to heat and raise the same in temperature.

6. The apparatus for manufacturing a tire belt member, according to claim 5, wherein a first pinch roll and a second pinch roll, which serve as a feeding device of the belt cord, are arranged at an interval in a feeding direction to posses the straightness correcting function and the warm-up device and the rubber covering die are provided in series between the first pinch roll and the second pinch roll.

7. The apparatus for manufacturing a tire belt member, according to any one of claims 4 to 6, wherein a straightness correcting line, on which plural pairs of forming rolls are arranged to interpose a rubber covered cord from both sides to correct straightness thereof, is provided on a downstream side of a straight fed portion of the belt cord.

8. The apparatus for manufacturing a tire belt member, according to anyone of claims 4 to 6, wherein the straightness correcting means of the constant rate cut line having the forwarding function comprises plural pairs of forming rolls that interpose a rubber covered cord from both sides to correct straightness thereof, and the forming rolls are provided to be enabled by drive means connected thereto to be rotationally driven to forward a rubber covered cord as cut.

9. The apparatus for manufacturing a tire belt member, according to any one of claims 4 to 6, wherein the junction device on the alignment table comprises a roller that receives the rubber covered cord as cut and fed from the constant rate cut line in a manner to align the same with the rubber covered cord as aligned on the alignment table, and push means that makes use of a cam mechanism to pressure contact and join the rubber covered cord as cut and fed onto the roller to the rubber covered cord as aligned.
